(19) United States
(12) Patent Application Publication
(10) Pub. No.: US 2017/0329796 A1
(43) Pub. Date: Nov. 16, 2017

(54) SYSTEMS AND METHODS FOR CONTEXT-BASED FILE SHARING

(71) Applicant: Motorola Mobility LLC, Chicago, IL (US)

(72) Inventors: Satyabrata Rout, Bangalore (IN); Amit Kumar Agrawal, Bangalore (IN)

(21) Appl. No.: 15/154,452

(22) Filed: May 13, 2016

(51) Int. Cl. G06F 17/30; H04L 29/08

(52) U.S. Cl. CPC G06F 17/30174; H04L 67/18; G06F 17/30091; H04L 67/06

(57) ABSTRACT

Systems and methods process files on an electronic device to enable context-based sharing of the files associated with an event, and to ease and simplify the user experience. According to certain aspects, an electronic communication including a request to share files may be parsed for keywords related to an event. Files stored on the electronic device may be processed to determine whether the files are associated with the event, based on the keywords. Files that are determined to be associated with the event may be processed to enable context-based sharing, such as by associating an event-specific sharing option, adding metadata, or displaying the associated files. Increased collaboration and participation by users to share files associated with an event may result through the use of these systems and methods.

### FIELD

This application generally relates to context-based sharing of files on an electronic device. In particular, this application relates to parsing an electronic communication received at an electronic device to enable automated context-based sharing of files stored in the electronic device that are associated with an event.

### BACKGROUND

Electronic devices, such as smartphones and tablet computers, have become ubiquitous. Users of electronic devices typically generate files that are stored on the electronic devices, such as when taking photos and videos or composing e-mails. The files that are stored on the electronic devices may include, for example, images, videos, and documents.

Often, multiple users may attend an event where each user generates files that are associated with the event on their respective electronic devices. For example, multiple users may attend a party, family reunion, or other gathering where they have taken images and videos. As another example, multiple users may be participants in a business meeting where spreadsheet and word processing documents have been generated.

After the event, the users may desire to collaborate and consolidate the files stored on their electronic devices in a centralized location. Typically, one of the users may send a request to the other users to share files associated with the event. The request may be included, for example, in a message (e.g., e-mail, text message, instant message, etc.) that includes a link to a destination location. The users would then need to manually upload each of the relevant files to the destination location, which may often involve multiple steps. However, this may be cumbersome and time consuming for users and may discourage sharing of the files. For example, users may need to go through the files one by one on their electronic devices to determine which files are relevant to the event. As another example, users may have moved their files to another electronic device or to external storage.

Accordingly, there is an opportunity for systems and methods that ease and simplify the sharing of files stored on electronic devices that are associated with an event.

### SUMMARY

In an embodiment, a method includes receiving an electronic communication at a processor of an electronic device; parsing the electronic communication using the processor to determine one or more keywords in the electronic communication associated with an event; determining whether at least one file stored on the electronic device is associated with the event, using the processor, based on the one or more keywords; and in response to determining that at least one file is associated with the event, processing the at least one file to enable context-based sharing of the at least one file. The processing of the at least one file may include associating an event-specific sharing option with the at least one file on the electronic device, wherein the event-specific sharing option is operable to enable a user to transmit the at least one file to a destination location specified in the one or more keywords. The processing of the at least one file may include adding metadata based on the one or more keywords to the at least one file. The processing of the at least one file may include displaying the at least one file associated with the event on a display of the electronic device.

In another embodiment, an electronic device includes a display, a transceiver, a processor operatively coupled with the display and the transceiver, and a memory operatively coupled with the processor. The memory may include at least one file, a communications module, and a mapper module. The communications module may be configured to cause the processor to receive an electronic communication, and parse the electronic communication to determine one or more keywords in the electronic communication associated with an event. The mapper module may configured to cause the processor to determine whether the at least one file is associated with the event, based on the one or more keywords, and in response to determining that the at least one file is associated with the event, process the at least one file to enable context-based sharing of the at least one file. The mapper module may be configured to cause the processor to process the at least one file by associating an event-specific sharing option with the at least one file on the electronic device, wherein the event-specific sharing option is operable to enable a user to transmit the at least one file to a destination location specified in the one or more keywords. The mapper module may be configured to cause the processor to process the at least one file by displaying the at least one file associated with the event on a display of the electronic device.

In a further embodiment, an electronic device includes a display, a transceiver, a processor operatively coupled with the display and the transceiver, and a memory operatively coupled with the processor. The memory may include at least one file, a communications module, and a mapper module. The communications module may be configured to cause the processor to receive an electronic communication, and parse the electronic communication to determine one or more keywords in the electronic communication associated with an event. The mapper module may configured to cause the processor to determine whether the at least one file is associated with the event, based on the one or more keywords, and in response to determining that the at least one file is associated with the event, add metadata based on the one or more keywords to the at least one file.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed embodiments, and explain various principles and advantages of those embodiments.

FIG. 1 is a block diagram of a file mapper system included in an electronic device, in accordance with some embodiments.

FIG. 2 is a flow diagram depicting the processing of files to enable context-based sharing by associating an event-specific sharing option with the files, in accordance with some embodiments.

FIG. 3 is a flow diagram depicting the processing of files to enable context-based sharing by adding metadata associated with an event to the files, in accordance with some embodiments.

FIG. 4 is a flow diagram depicting the processing of files to enable context-based sharing by displaying related files associated with an event, in accordance with some embodiments.

FIG. 5 is a flow diagram depicting the processing of files to enable context-based sharing by retrieving existing tags and associating an event-specific sharing option with the files, in accordance with some embodiments.

FIG. 6 is a flow diagram depicting the parsing of an electronic communication for keywords, in accordance with some embodiments.

### DETAILED DESCRIPTION

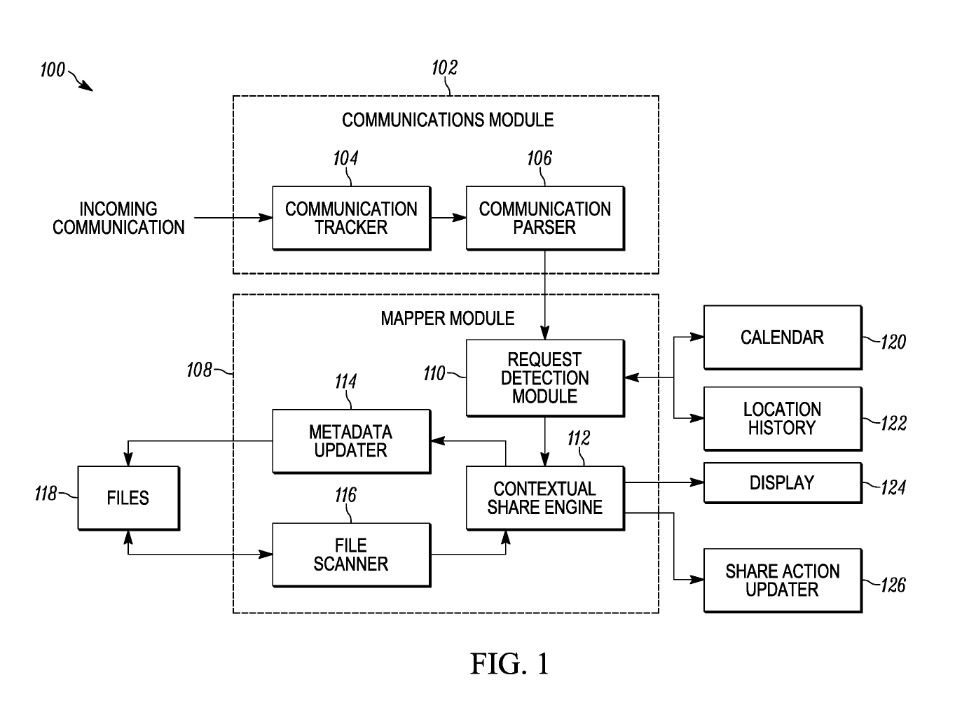

FIG. 1 illustrates a file mapper system 100 included in an electronic device in which embodiments may be implemented. The file mapper system 100 may process files 118 stored on the electronic device to enable context-based sharing of the files 118. In particular, files 118 that are stored on electronic devices and that are associated with events may be more easily shared by users. The files 118 may include images, videos, and/or documents, for example. The files 118 may be processed to enable context-based sharing, in response to receiving an electronic communication, parsing the electronic communication to determine keywords associated with an event, and determining whether files stored on the electronic device are associated with the event, based on the keywords. The processing of the files 118 may include associating an event-specific sharing option with the files 118, adding metadata based on the keywords to the files 118, and/or displaying files 118 associated with the event. Keywords in the electronic communication may be related to actions, locations, and/or other information associated with the event. Less effort may be needed from users to share files associated with the event from their electronic devices, which can result in increased collaboration and participation. It should be appreciated that other benefits and efficiencies are envisioned.

The electronic device may be stationary or portable and may be, for example, a smartphone, a cellular phone, a personal digital assistant, a tablet computer, a laptop computer, a desktop computer, a networked television set, or the like. The file mapper system 100 may include a communications module 102 having a communication tracker 104 and a communication parser 106, and a mapper module 108 having a request detection module 110, a contextual share engine 112, a metadata updater 114, and a file scanner 116. As described below, the request detection module 110 may be operatively coupled with a calendar 120 and location history 122 on the electronic device, and the contextual share engine 112 may be operatively coupled with a display 124 and a share action updater 126 on the electronic device. The metadata updater 114 may write to the files 118 stored on the electronic device, and the file scanner 116 may read from and/or write to the files 118, as described below.

The software in the memory of the electronic device may include one or more separate programs or applications. The programs may have ordered listings of executable instructions for implementing logical functions. The software may include a suitable operating system of the electronic device, such as Android from Google, Inc., iOS from Apple. Inc., or Windows Phone and Windows 10 Mobile from Microsoft Corporation. The operating system essentially controls the execution of other computer programs, and provides scheduling, input-output control, file and data management, memory management, and communication control and related services.

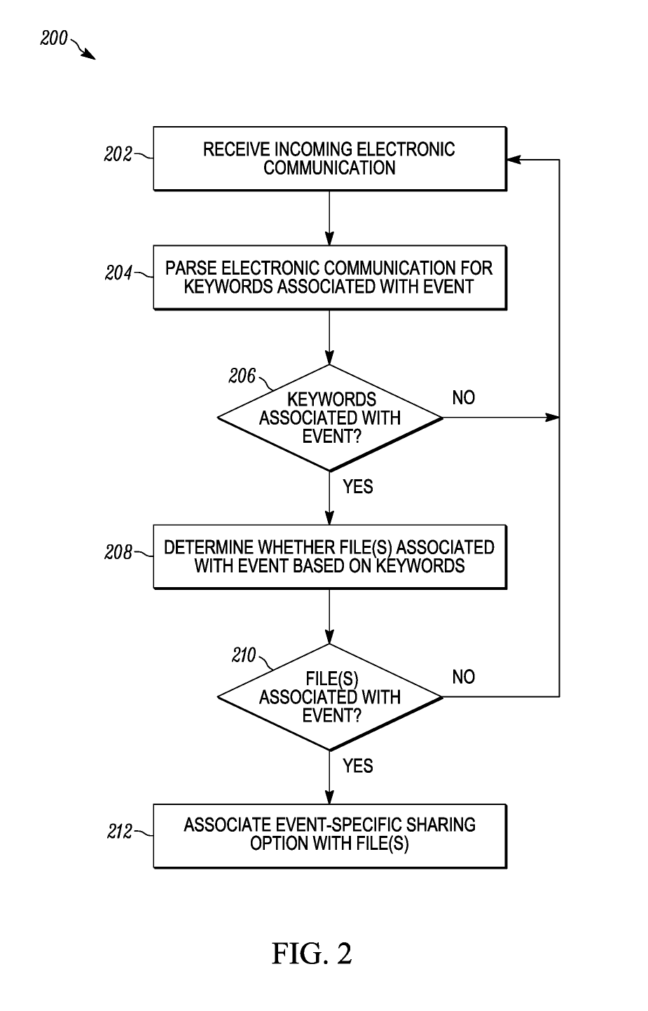

FIGS. 2-6 illustrate embodiments of methods 200, 300, 400, 500, 600 for processing files to enable context-based sharing using the file mapper system 100. In general, a computer program product in accordance with the embodiments includes a computer usable storage medium (e.g., standard random access memory (RAM), an optical disc, a universal serial bus (USB) drive, or the like) having computer-readable program code embodied therein, wherein the computer-readable program code is adapted to be executed by the processor (e.g., working in connection with an operating system) to implement the methods described below. In this regard, the program code may be implemented in any desired language, and may be implemented as machine code, assembly code, byte code, interpretable source code or the like (e.g., via C, C++, Java, Actionscript, Objective-C, Javascript, CSS, XML, and/or others).

The electronic device may also include additional I/O components (not shown such as keys, buttons, lights, LEDs, microphones, sensors, speakers, cursor control devices, haptic devices, etc. The display 124 and the additional I/O components may be considered to form portions of a user interface (e.g., portions of the electronic device associated with presenting information to the user and/or receiving inputs from the user). In some embodiments, the display 124 is a touchscreen display composed of singular or combinations of display technologies such as electrophoretic displays, electronic paper, polyLED displays, OLED displays, AMOLED displays, liquid crystal displays, electrowetting displays, rotating ball displays, segmented displays, direct drive displays, passive-matrix displays, active-matrix displays, lenticular barriers, and/or others. Further, the display 124 can include a thin, transparent touch sensor component superimposed upon a display section that is viewable by a user. For example, such displays include capacitive touch screens, resistive touch screens, surface acoustic wave (SAW) touch screens, optical imaging touch screens, and the like.

The communication tracker 104 may detect and receive an incoming electronic communication to the electronic device, such as at step 202, 302, 402, 502 of method 200, 300, 400, 500 shown in FIGS. 2-5, respectively. The incoming communication may be an email, text message, or instant message, for example. The incoming message may be received through a transceiver (not shown) of the electronic device that sends and receives data over a network, for example. The transceiver may be adapted to receive and transmit data over a wireless and/or wired connection. The transceiver may function in accordance with the IEEE 802.11 standard or other standards. More particularly, the transceiver may be a WWAN transceiver configured to communicate with a wide area network including one or more cell sites or base stations to communicatively connect the electronic device to additional devices or components. Further, the transceiver may be a WLAN and/or WPAN transceiver configured to connect the electronic device to local area networks and/or personal area networks, such as a Bluetooth network.

The incoming communication detected and received by the communication tracker 104 may include keywords associated with an event in its text, images, source code, hyperlinks, and/or attachments. The communication parser 106 may parse the incoming communication to determine keywords in the communication, such as at step 204, 304, 404, 504 of method 200, 300, 400, 500, respectively. In other words, the communication parser 106 may convert the incoming communication from an unstructured format to a structured format by determining keywords in the communication.

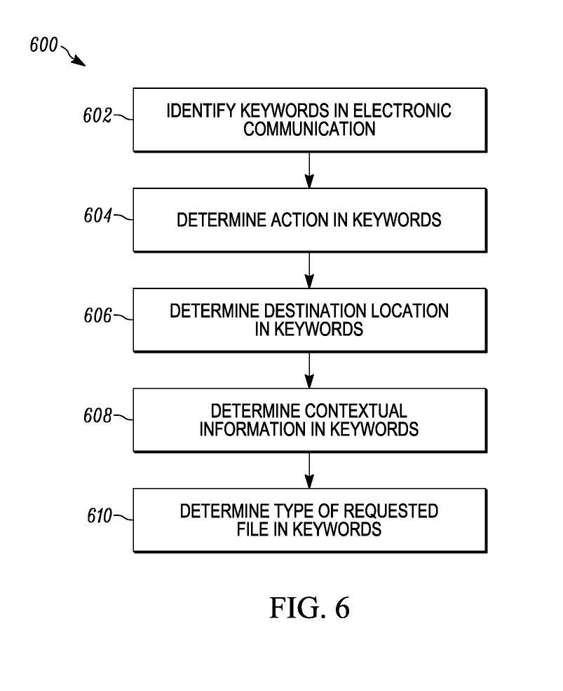

An embodiment of step 204, 304, 404, 504 for parsing an incoming communication is shown in the method 600 of FIG. 6. At step 602, the communication parser 106 may identify keywords in the electronic communication. In some embodiments, keywords may include words that are not common and/or are known to be actions, destination locations, types of files, and/or contextual information, as described below. The keywords identified at step 602 may be processed by the communication parser 106 to determine whether any of the keywords are an action, at step 604. Actions in a communication may include, for example, requests to share files associated with an event. This may include portions or entireties of terms and phrases such as “request to share”, “request to collaborate”, “please upload files”, “please contribute”, and/or other similar terms and phrases. At step 606, the keywords identified at step 602 may be processed by the communication parser 106 to determine whether any of the keywords are a destination location. Destination locations may include electronic storage locations (e.g., folders, hyperlinks, etc.) that are accessible via the transceiver, such as cloud storage services (e.g., Google Drive, Dropbox, etc.), network drives, and/or other storage locations.

At step 608, the keywords identified at step 602 may be processed by the communication parser 106 to determine whether any of the keywords are contextual information. Contextual information may include other pertinent data in the incoming communication, such as recipients of the communication, participants in the event, the event name, the location of the event, date, and/or time, for example. At step 610, the identified keywords may be processed by the communication parser 106 to determine whether any of the keywords are a requested type of file. Types of files parsed from the incoming communication may include general types (e.g., photo, video, Word document, Excel spreadsheet, etc.), and/or a specific MIME (Multipurpose Internet Mail Extensions) type of the requested files. In some embodiments, the user may be able to customize the keywords that are identified as actions, destination locations, contextual information, and/or requested types of files. In some embodiments, contextual information such as the recipients of the communication and the participants in the event, may be compared to face tags in photos and/or videos of the files 118 to determine which files 118 may be associated with the event.

Returning to FIG. 1, the request detection module 110 may determine whether the keywords (i.e., actions, destination locations, contextual information, and/or type of file, as determined at step 204, 304, 404, 504) are associated with the event, such as at step 206, 306, 406, 506 of method 200, 300, 400, 500, respectively. In embodiments, the request detection module 110 may communicate with the calendar 120 and/or the location history 122 on the electronic device to assist in determining whether the keywords are related to actions, destination locations, contextual information, and/or types of requested files that are associated with the event. For example, calendar entries from the calendar 120 and/or location history entries from the location history 122 may be compared to the keywords parsed from the incoming communication to determine whether particular keywords are actions, destination locations, contextual information, and/or types of requested files associated with the event. The calendar 120 may include a calendar stored locally on the electronic device and/or a calendar stored remotely from the electronic device. The location history 122 may include automatically and/or manually recorded entries of the geographical locations where the electronic device has been.

If it is determined that at step 206, 306, 406, 506 that the keywords are not associated with the event, then the method 200, 300, 400, 500 may return to step 202, 302, 402, 502 to receive an incoming communication. However, if it is determined at step 206, 306, 406, 506 that the keywords are associated with the event, then the method 200, 300, 400, 500 may continue as described below.

In the embodiments shown in method 200, 300, 400, the contextual share engine 112 may determine whether there are files 118 associated with the event at step 208, 308, 408, based on the keywords determined by the request detection module 110. In particular, the contextual share engine 112 may control the file scanner 116 to retrieve tags of the files 118 to determine if there are matches to the determined keywords. If it is determined that a particular file 118 is associated with the event at step 210, 310, 410, then the file 118 may be denoted to be associated with the event and the methods 200, 300, 400 may respectively continue to step 212, 312, 412 as described below. However, if it is determined that a particular file 118 is not associated with the event at step 210, 310, 410, then the method 200, 300, 400 may return to step 202, 302, 402 to receive an incoming communication. In embodiments, the contextual share engine 112 may determine whether a file 118 has already been processed to enable context-based sharing for the event, even if keywords match tags of the file 118. For example, a particular file 118 may have previously been shared by the user to the destination location. In this case, such files 118 may be denoted as not associated with the event so that the files 118 are not shared again.

In some embodiments, it may be determined at step 210, 310, 410 that a file 118 is associated with an event if at least one of the keywords matches at least one tag of a file 118. In other embodiments, there may be a threshold number of matching keywords and tags of a file 118 at steps 210, 310, 410 to denote that a file 118 is associated with an event. In further embodiments, the keywords and/or tags of files 118 may have different weights or importance. For example, location, date, time, and/or type of file may be considered to be more important than other keywords and/or tags because they may be more specific and therefore more helpful in determining whether a file 118 is associated with an event.

The tags of the files 118 may have been previously determined and stored with the files 118 by other applications. The tags of the files 118 may include geographical locations, dates, times, face tags, last modified dates and times, authors, etc. For example, Google Photos or another image processing application may have detected and stored the names of persons whose faces are in photos and/or videos in the files 118. As another example, Microsoft Word or another office application may have stored the author of a document and its last modified date and time in the files 118.

Regarding the embodiment shown in the method 500, the contextual share engine 112 may retrieve existing tags of files already stored at the destination location, if any, such as at step 508. The files at the destination location may have been previously stored by other users, for example, and already have existing tags. These existing tags may be retrieved and utilized at step 510 of the method 500, where the contextual share engine 112 may determine whether there are files 118 associated with the event, based on the keywords determined by the request detection module 110 (at step 506) and/or the retrieved tags of the previously stored files at the destination location (at step 508).

In particular, the contextual share engine 112 may control the file scanner 116 to retrieve tags of the files 118 to determine if there are matches to the determined keywords (as described above with reference to methods 200, 300, 400) and/or to the retrieved tags of the previously stored files at the destination location. If it is determined that a particular file 118 is associated with the event at step 512, then the file 118 may be denoted to be associated with the event and the method 500 may continue to step 514 as described below. However, if it is determined that a particular file 118 is not associated with the event at step 512, then the method 500 may return to step 502 to receive an incoming communication.

The following describes examples of determining whether a particular file 118 is associated with an event (i.e., at step 210, 310, 410, 512 described above). As an example, an incoming electronic communication may include keywords that are parsed by the file mapper system 100 for an action (e.g., “Please upload”), a destination location (e.g., a Google Drive folder for the event), and contextual information “5th birthday party”, “McDonald's”, and “January 20”). Because an action has been found that indicates a request to share files, the file mapper system 100 may determine whether there are any files 118 on the electronic device that are associated with the event, based on the keywords. The files 118 may include photos and/or videos with tags indicating the dates when the photos were taken and the locations where the photos and/or videos were taken, for example. The photos and/or videos with tags that match the keywords from the incoming communication can he denoted as associated with the event (i.e., “5th birthday party”). The incoming communication may also include a list of recipients and/or participants which can be parsed as keywords. The list of recipients and/or participants may be compared to face tags in the photos and/or videos of the files 118 to determine which files 118 may be associated with the event.

As another example, an incoming electronic communication may include keywords that are parsed by the file mapper system 100 for an action (e.g., “Submit your status reports”), a destination location (e.g., a shared network drive), and contextual information (e.g., “brainstorming session”, “9 am, October 14”, and “Excel”). Similar to the previous example, an action has been found that indicates that sharing of files is being requested. The file mapper system 100 may therefore determine whether there are any files 118 on the electronic device that are associated with the event, based on the keywords. The files 118 may include Excel spreadsheets (as a type of file) that have a last modified date of October 14. The files 118 with tags that match the keywords from the incoming communication can be denoted as associated with the event (i.e., “brainstorming session”).

As a further example, an incoming electronic communication may include keywords that are parsed by the file mapper system 100. However, in this example, there are no keywords for an action, destination location, and contextual information. Instead, the incoming communication is an advertising email from a retailer. In this case, the file mapper system 100 would not find any keywords associated with an event, and no files 118 stored on the electronic device would be associated with an event.

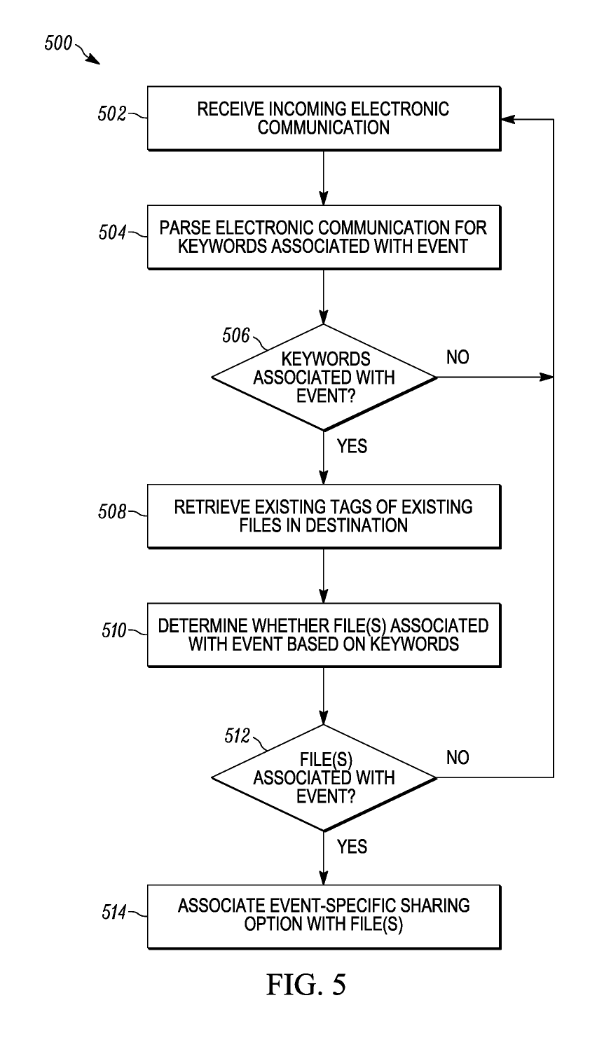

Returning to FIG. 1, after it has been determined which of the files 118 are associated with the event, the contextual share engine 112 may process the associated files 118 to enable context-based sharing of the associated files 118. In the embodiments shown in the methods 200 of FIG. 2 and 500 of FIG. 5, the contextual share engine 112 may control the share action updater 126 to associate an event-specific sharing option with the associated files 118, such as at step 212 and 514. For example, the share action updater 126 may add a sharing option for a particular photo that enables a user to click the sharing option to upload the photo directly to the destination location specified in the incoming communication. The added sharing option may, for example, appear as an additional selectable icon in the “Share via” list of options for the associated files 118.

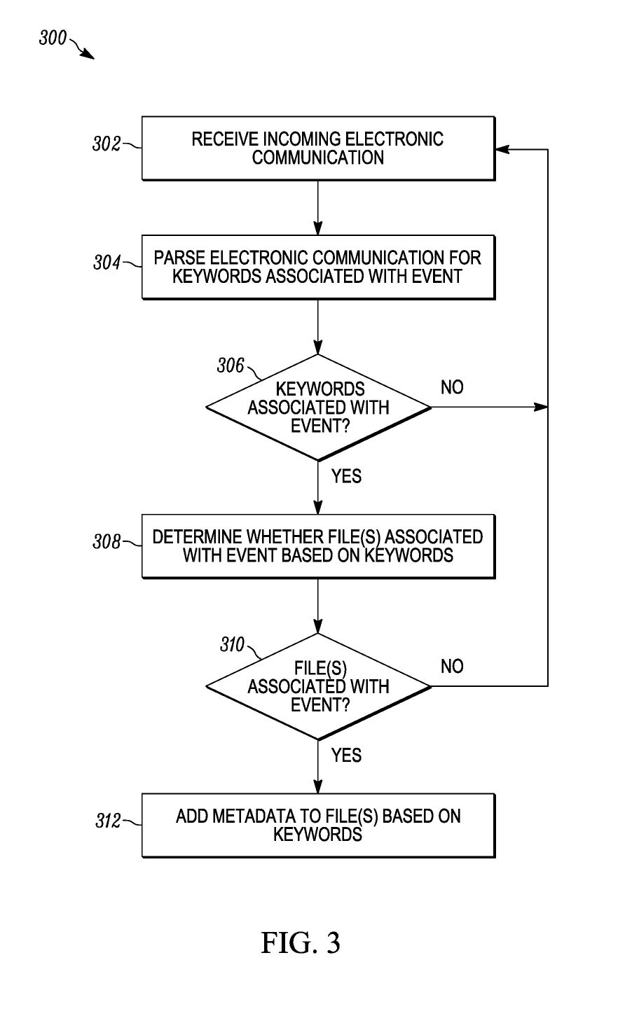

In the embodiment shown in the method 300 of FIG. 3, the contextual share engine 112 may process the associated files 118 to enable context-based sharing by controlling the metadata updater 114 to add metadata to the associated files 118, such as at step 312. The metadata may be based on the keywords determined by the request detection module 110. For example, the metadata updater 114 may add metadata such as the destination location to the associated files 118. In this way, the added metadata may remain with the associated files 118 even if the associated files 118 are moved to other electronic devices. Other electronic devices may read the added metadata stored with the associated tiles 118 so that the tiles may still be easily shared from the other electronic devices. As another example, the metadata updater 114 may add metadata such as the event name and geographical location. This type of metadata may be helpful for subsequent users to retrieve existing tags of already-uploaded files, such as in the method 500 described above. In some embodiments, the added metadata may be encrypted, in other embodiments, the added metadata may be stripped if the files 118 are shared with another user or entity (e.g., uploaded to social media or a public photo/video sharing website).

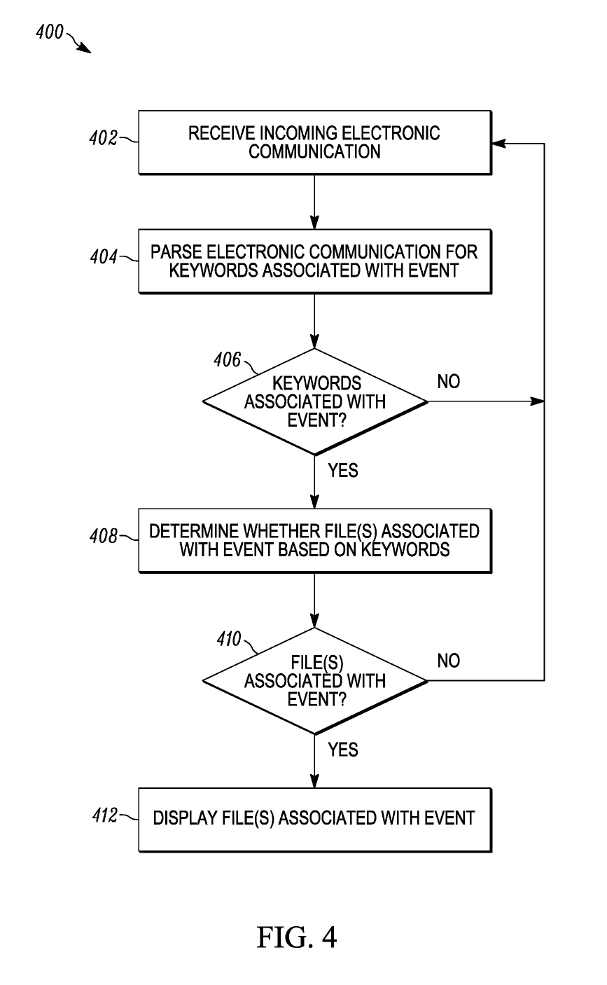

In the embodiment shown in the method 400 of FIG. 4, the contextual share engine 112 may process the associated files 118 to enable context-based sharing by controlling the file scanner 116 to retrieve and display a list of the associated files 118, such as at step 412. The list of associated files 118 may be displayed on the display 124 to the user. In some embodiments, the user may select some or all of the displayed associated files 118 on the display 124 for upload to the destination location. In this way, not all the file 118 may be uploaded, if it is not desired.

In some embodiments, a user may have the ability to disassociate files 118 that have been associated with an event by the file mapper system 100. For example, the file mapper system 100 may have associated particular files 118 that happen to have been created on the same day as an event specified in an incoming communication with a request to share. In this case, the user would not want to share such files 118 since these files would not actually be related to the event.

Thus, it should be clear from the preceding disclosure that systems and methods for context-based sharing of files on an electronic device may be performed to ease and simplify the user experience. The systems and methods can reduce the amount of effort needed from users to share files associated with an event from their electronic devices, which can result in increased collaboration and participation.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent,and all equivalents thereof, when interpreted in accordance with the breadth to which they are fairly, legally and equitably entitled.

1. A method comprising:
receiving an electronic communication at a processor of an electronic device;
parsing the electronic communication using the processor to determine one or more keywords in the electronic communication associated with an event;
determining whether at least one file stored on the electronic device is associated with the event, using the processor, based on the one or more keywords; and
in response to determining that the at least one file is associated with the event, processing the at least one file to enable context-based sharing of the at least one file.

2. The method of claim 1, wherein processing the at least one file comprises associating an event-specific sharing option with the at least one file on the electronic device, wherein the event-specific sharing option is operable to enable a user to transmit the at least one file to a destination location specified in the one or more keywords.

3. The method of claim 1, wherein processing the at least one file comprises adding metadata based on the one or more keywords to the at least one file.

4. The method of claim 1, wherein processing the at least one file comprises displaying the at least one file associated with the event on a display of the electronic device.

5. The method of claim 1, wherein parsing the electronic communication comprises:
identifying the one or more keywords in the electronic communication;
determining an action in the one or more keywords, wherein the action denotes a request to share the at least one file associated with the event;
determining a destination location m the one or more keywords; and
determining contextual information associated with the event in the one or more keywords.

6. The method of claim 1, wherein determining whether the at least one file is associated with the event comprises:
determining whether the one or more keywords match one or more tags associated with the at least one file; and
in response to determining that the one of more keywords match the one or more tags, denoting that the at least one file is associated with the event.

7. The method of claim 1, wherein determining whether the at least one file is associated with the event comprises:
determining whether the one or more keywords are related to a history record associated with the at least one file, the history record stored on the electronic device and comprising one or more of a calendar entry or location history entry; and
in response to determining that the one or more keywords are related to the history record, denoting that the at least one file is associated with the event.

8. The method of claim 1, wherein:
parsing the electronic communication further comprises determining a type of requested file in the one or more keywords; and
determining whether the at least one file is associated with the event comprises determining whether the type of requested the matches a type of the at least one file.

9. The method of claim 1, wherein determining whether the at least one file is associated with the event comprises:
determining whether the at least one file has already been processed to enable the context-based sharing; and
in response to determining that the at least one file has already been processed, denoting that the at least one tile is not associated with the event,

10. The method of claim 1:
further comprising retrieving one or more existing tags associated with one or more existing files in a destination location specified in the one or more keywords;
wherein determining whether the at least one file is associated with the event comprises:
determining whether the one or more existing tags associated with the one or more existing files match one or more tags associated with the at least one file; and
in response to determining that the one or more keywords match the one or more existing tags, denoting that the at least one file is associated with the event.

11. An electronic device, comprising:
a display;
a transceiver;
a processor operatively coupled with the display and the transceiver; and
a memory operatively coupled with the processor, the memory comprising:
at least one file;
a communications module configured to cause the processor to:
receive an electronic communication; and
parse the electronic communication to determine one or more keywords in the electronic communication associated with an event; and
a mapper module configured to cause the processor to:
determine whether the at least one file is associated with the event, based on the one or more keywords; and
in response to determining that the at least one file is associated with the event, process the at least one file to enable context-based sharing of the at least one file.

12. The electronic device of claim 11, wherein the mapper module is configured to cause the processor to process the at least one file by associating an event-specific sharing option with the at least one file on the electronic device, wherein the event-specific sharing option is operable to enable a user to transmit the at least one file to a destination location specified in the one or more keywords.

13. The electronic device of claim 11, wherein the mapper module is configured to cause the processor to process the at least one file by displaying the at least one file associated with the event on the display of the electronic device.

14. The electronic device of claim 11, wherein the communications module is configured to cause the processor to parse the electronic communication by:
identifying the one or more keywords in the electronic communication;
determining an action in the one or more keywords, wherein the action denotes a request to share the at least one file associated with the event;
determining a destination location in the one or more keywords; and
determining contextual information associated with the event in the one or more keywords.

15. The electronic device of claim 11, wherein the mapper module is configured to cause the processor to determine whether the at least one file is associated with the event by:
determining whether the one or more keywords match one or more tags associated with the at least one file; and
in response to determining that the one of more keywords match the one or more tags, denoting that, the at least one file is associated with the event,

16. The electronic device of claim 11, wherein the mapper module is configured to cause the processor to determine whether the at least one file is associated with the event by:
determining whether the one or more keywords are related to a history record associated with the at least one file, the history record stored on the electronic device and comprising one or more of a calendar entry or location history entry; and
in response to determining that the one or more keywords are related to the history record, denoting that the at least one file is associated with the event.

17. The electronic device of claim 11, wherein:
the communications module is configured to cause the processor to parse the electronic communication further by determining a type of requested file in the one or more keywords; and
the mapper module is configured to cause the processor to determine whether the at least one tile is associated with the event by determining whether the type of requested file matches a type of the at least one file.

18. The electronic device of claim 11, wherein the mapper module is configured to cause the processor to determine whether the at least one file is associated with the event by:
determining whether the at least one file has already been processed to enable the context-based sharing; and
in response to determining that the at least one file has already been processed, denoting that the at least one tile is not associated with the event.

19. The electronic device of claim 11:
wherein the mapper module is further configured to cause the processor to retrieve one or more existing tags associated with one or more existing files in a destination location specified in the one or more keywords;
wherein the mapper module is configured to cause the processor to determine whether the at least one file is associated with the event by:
determining whether the one or more existing tags associated with the one or more existing files match one or more tags associated with the at least one file; and
in response to determining that the one or more keywords match the one or more existing tags, denoting that the at least one file is associated with the event.

20. An electronic device, comprising:
a display;
a transceiver;
a processor operatively coupled with the display and the transceiver; and
a memory operatively coupled with the processor, the memory comprising:
at least one file;
a communications module configured to cause the processor to:
receive an electronic communication; and
parse the electronic communication to determine one or more keywords in the electronic communication associated with an event; and
a mapper module configured to cause the processor to:
determine whether the at least one file is associated with the event, based on the one or more keywords; and
in response to determining that the at least one file is associated with the event, add metadata based on the one or more keywords to the at least one file.
